(19) United States
(12) Patent Application Publication
(10) Pub. No.: US 2003/0219302 A1
(43) Pub. Date: Nov. 27, 2003

(54) Slidable structural clamp and method

(76) Inventor: John A. Hill SR., Greenville, SC (US)

Correspondence Address: Ralph Bailey, RALPH BAILEY, PA, 125 Broadus Avenue, Greenville, SC, 29601, US

(21) Appl. No.: 10/151,326

(22) Filed: May 21, 2002

(51) Int. Cl. F16D 3/00

(52) U.S. Cl. 403/24

(57) ABSTRACT

A panel installation system for a building construction includes sliding a clamping member (C) along structural members having opposed flanges (B) for positioning acoustic or thermal panels (A) therebetween. The clamping members (C) receive bolts including a shank (D) extending therethrough and being carried at marginal portions of the panels. Lip members (E) on the backside of the sliding clamping members provide a slot accommodating one of the flanges for positioning the clamping member for securing the panels between respective structural members.

### BACKGROUND OF INVENTION

This invention relates to apparatus and method for facilitating the erection of building structures and more particularly to a clamp and method for installing a series of aligned side by side panels between structural components having Opposed flanges.

The prior art is represented by apparatus for joining adjacent panels to an intermediate structural member such as a column or beam wherein J-hooks are provided to apply tension for pulling the adjacent panels toward a column or beam. The J-hooks each have a shank passing through one of the opposed flanges at right angles to the flange and thence extending outwardly at an angle to attach a hooked end within a side of an adjacent panel for positioning respective panels between structural components such as columns or beams.

The prior art is further exemplified by the disclosure of U.S. Pat. No. 4,030,266, wherein sliding grooved members engage flanges of structural members carried at right angles thereto. Elongated shank members extend at right angles from the sliding grooved members into an open trackway of a second structural member for connection thereto.

Thus, the prior art necessitates passing bolts through holes in opposed flanges or into a member having a partially enclosed trackway. Apparatus and method constructed in accordance with the prior art for securement of aligned panels contemplates the use of tensioning members wherein the forces applied are exerted by asymmetrically configured J-hooks that fail to exert balanced forces upon adjacent panels.

Because structures of the prior art require the drilling of holes in respective flanges for receiving J-hooks for pulling adjacent panels together both shop fabrication time and erection or installation time are enlarged.

### SUMMARY OF THE INVENTION

Accordingly, it is an important object of this invention to provide an improved structural system for erecting enclosures providing sides and a roof for enclosing a machine to which access is limited and wherein acoustic and or thermally insulated panels are used to enclose the machine on all sides.

Another important object of the invention is the provision of a unitary clamp structure of symmetrical design that allows it to be used for attaching panels and the like between columns, beams and other structural members having opposed flanges. The clamps each include an elongated bridging member having a lip preferably providing a slot for receiving an opposed edge of the flanges of the respective structural elements.

Another important object of the invention is to provide a unitary clamping member adapted to slide on the structural members to join panels and the like on either side of the columns or beams wherein the problem of bringing the components into alignment is alleviated due to the sliding, clamping or bridging members that allow such fastening members to be forgiving of erection tolerances and alignment of wall and roof panels.

Another important object of the invention is the provision of an enclosed structure of such integrity as to allow for a tight fit between the panels and the structural framework for eliminating leaks from a thermal or acoustical interior.

Another important object of the invention is ease of fabrication or erection of building structures utilizing simplified clamping devices that avoid the necessity of providing holes in flanges of structural components thus expediting construction.

Structures incorporating the apparatus and erected in accordance with the invention are particularly useful for enclosing machines such as turbines for generating electricity, which are exceptionally noisy having an otherwise unacceptable decibel levels for persons in nearby areas of a plant.

While the invention has been described in the context of securing panels by means of slidable clamping members to vertical and horizontal structural members for assembling panels therebetween, it is to be understood that constructions may be utilized wherein intermediate structural members other than panels may be employed in lieu of building constructions exemplified herein. Columns or beams may be single members or they may be composite built up sections combining channels, angles, wide flange beams or any other of the well known structural sections.

### BRIEF DESCRIPTION OF THE DRAWINGS

The construction designed to carry out the invention will be hereinafter described, together with other features thereof.

The invention will be more readily understood from a reading of the following specification and by reference to the accompanying drawings forming a part thereof, wherein an example of the invention is shown and wherein:

FIG. 1 is a perspective view illustrating a structural system having elongated acoustic panels, that are broken away for clarity of illustration, wherein a base member carries columns for supporting the panels. A 90 degree version of the elongated slidable clamping members, not shown, may be provided for joining a side section at right angles to that illustrated in the drawing. A roof structure may be incorporated having additional sliding clamping members for fabricating roof structures employing beams and panels for attachment to adjacent vertical structural columns;

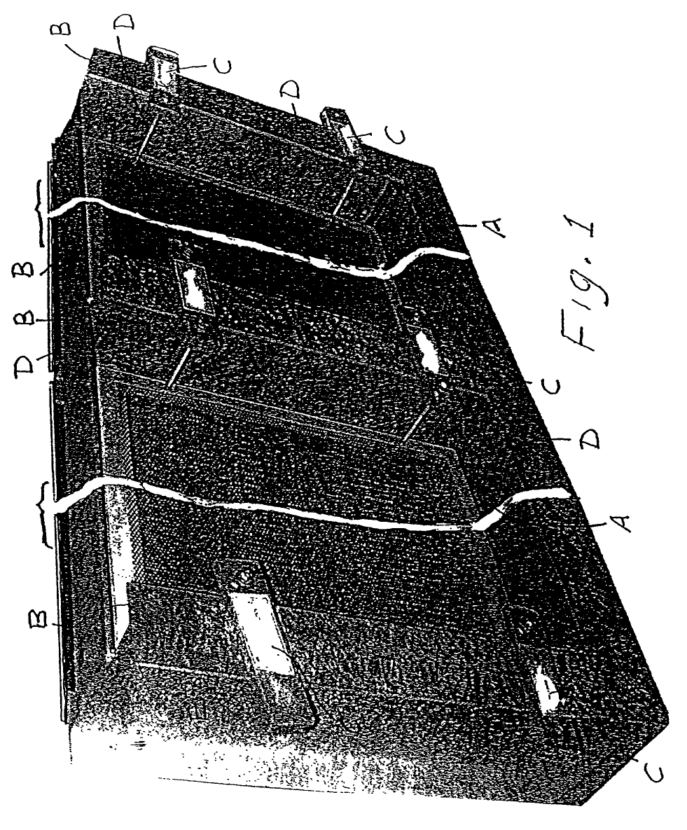

FIG. 2 is a front elevation with parts broken away illustrating adjacent panels as in FIG. 1 fastened to spaced structural columns or other structural members having opposed flanges wherein the clamping members include horizontal bridging members slidably carried along adjacent structural supports for positioning panels between the flanges either at the front or the back thereof through bolts that are carried by flanged portions of the panels; and

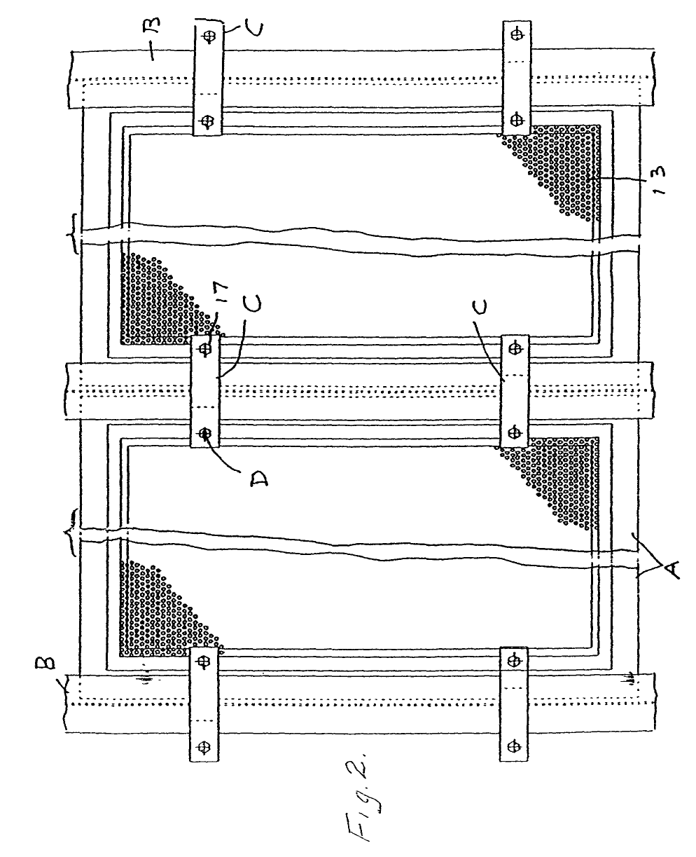

FIG. 3 is a top plan view looking down upon the structure illustrated in FIGS. 1 and 2 for illustrating the mode of attachment of the shanks of the bolts in fixtures carried upon the panels for providing torsion bolts for jacking the panel edges into engagement with the structural members securing a deformable gasket between a backing member and a panel for assuring structural integrity and a tight fit between the panels and the structural members.

### DESCRIPTION OF A PREFERRED EMBODIMENT

The drawings illustrate a clamp and method for fastening a series of aligned side by side panels A between structural members having opposed flanges B. An elongated bridging member C is slidable longitudinally along adjacent flanges and extends across adjacent structural members. A bolt D having a shank extending through the respective bridging member outside of the adjacent structural members is fastened to adjacent panels. A lip E on the bridging member engages an edge of a flange carried by a structural member positioning the clamp along the adjacent structural members. Thus erection of enclosures is expedited without the necessity of passing bolts through holes placed in the flanges of the structural members.

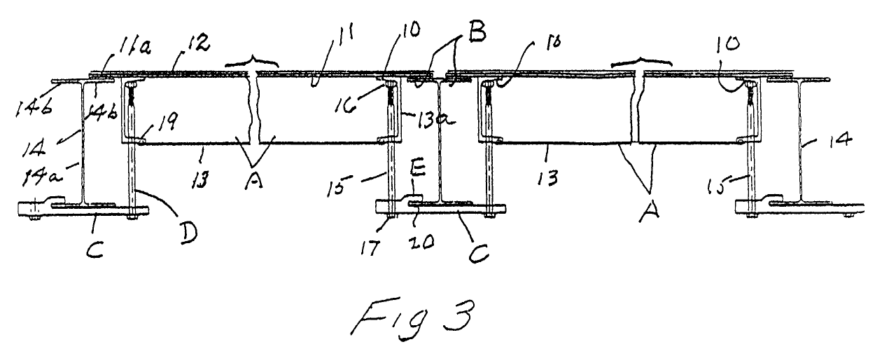

The panels A are best illustrated in FIG. 3 as having an enclosure for containment of acoustic or thermal insulation material, not shown. The panels are further illustrated as including inwardly extending flanges 10 accommodating a gasket 11 constructed of deformable rubbery material compressed by a backing member 12, providing compressed end portions 11a for assuring a snug fit. The panels include end members having flanges 10 arranged for connection to the columns 14 illustrated in the drawings. The columns include web members 14a and opposed flanges 14b. The front side of the panels illustrated at 13 is preferably expanded metal.

The bridging members C extend across the flanges comprising the structure members illustrated as columns 14 having a web 14a carrying flanges 14b. The structural members may take the form built up sections including wide flanged beams as illustrated or a pair opposed channel members forming a composite structural section so as to include opposed flanges B. The elongated bridging members carry bolts having shank members 15 adjacent each end of the sliding clamping members. The bolts are carried within a fixture 16 on a flange 10 of respective panel end supports. The other end of the shanks are provided with nuts 17 for jacking the panels inwardly of the enclosure. The shanks pass through inwardly extending flanges 19 of the end panel members 13a. A lip E on the bridging member defines a slot 20 for receiving an edge of the opposed flanges B for positioning the clamp for slidable movement along the adjacent structural members.

While a preferred embodiment for the invention is for illustrative purposes only, it is to be understood that changes and variations may be made in the various structural components and in their arrangement without departing from the spirit or scope of the following claims.

What is claimed is:

1. A clamp for fastening a series of aligned side by side panels between structural members having opposed flanges comprising:
an elongated bridging member slidable longitudinally and extending across opposed flanges of the respective structural members;
a bolt having a shank extending through the respective bridging members outside of the structural members fastened to adjacent panels; and
a lip on the bridging member engaging an edge of a flange carried by a structural member a bridging member the clamp for sliding movement along the structural members;
whereby erection of enclosures formed by the panels and structural members are expedited without the necessity of passing bolts through holes in the flanges of the structural members.

2. The clamp set forth in claim 1 including a gasket extending across a back of the panels and the flanges, and a backing member retaining the gasket in compressed relation thereto.

3. The clamp set forth in claim 1 including fixtures carried by marginal portions of the panels retaining the shanks therein.

4. The clamp set forth in claim 3 including torque bolts threadably carried by the shank for exerting an axial force on the shanks jacking the panels tightly within the flanges.

5. The clamp set forth in claim 1 wherein a single lip is carried on a back surface on one end of the elongated bridging members for slidably positioning the elongated bridging member on the opposed flanges.

6. The clamp set forth in claim 5 wherein the lip defines a slot for receiving an edge of a flange.

7. A building structure having a series of aligned components between structural members having opposed flanges comprising:
an elongated bridging member slidable longitudinally along the flanges and extending across a respective structural member;
a fastener having a shank connected to the bridging member on each opposite side of the respective structural member fastened to adjacent panels; and
a lip on said bridging member engaging an edge of a flange carried by a structural member for slidably positioning the elongated bridging member;
whereby erection the building structures is expedited.

8. The building structure set forth in claim 7 including side walls and a roof for completely surrounding a machine.

9. A method of installing a series of aligned panels between structural members having opposed flanges comprising the steps of:
positioning an elongated bridging member for longitudinal sliding movement along the flanges of the structural members and extending across a respective structural member;
fastening a bolt having a shank extending through the bridging member on an outside of the respective structural members fastened to each adjacent panel; and
engaging a lip on the bridging member with an edge of a flange carried by a structural member providing for said sliding movement and securing adjacent panels to a structural member;
whereby installation is expedited and it is unnecessary to pass bolts through holes in the flanges.

10. The method set forth in claim 9 including the step of forming walls and roof members from the panels and structural members.

11. The method set forth in claim 9 including the step of providing a slot between the lip and a rear surface of the elongated slidable member for receiving one of said flanges for carrying the elongated bridging member for sliding movement on the flanges.
